(19) United States
(12) Patent Application Publication
(10) Pub. No.: US 2009/0009530 A1
(43) Pub. Date: Jan. 8, 2009

(54) Method and Apparatus for Automatic Display of Pictures in a Digital Picture Frame

(75) Inventors: John Araki, Santa Fe Springs, CA (US); Howard Houng, Santa Fe Springs, CA (US)

Correspondence Address: KLEINBERG & LERNER, LLP, 2049 CENTURY PARK EAST, SUITE 1080, LOS ANGELES, CA, 90067, US

(73) Assignee: WESTINGHOUSE DIGITAL ELECTRONICS, LLC, Santa Fe Springs, CA (US)

(21) Appl. No.: 12/172,191

(22) Filed: Jul. 11, 2008

Related U.S. Application Data
(62) Division of application No. 11/425,108, filed on Jun. 19, 2006.

(51) Int. Cl. G09G 5/00

(52) U.S. Cl. 345/619; 345/667

(57) ABSTRACT

A method for displaying a photograph on a digital picture frame comprising the steps of: retrieving a digital image file containing the picture from a digital storage media device; detecting an orientation of the photograph; and displaying the image on the digital picture frame in the correct orientation on a display unit of the digital picture frame.

### CROSS-REFERENCE TO RELATED APPLICATIONS

The present application is a divisional of the U.S. patent application Ser. No. 11/425,108 filed Jun. 19, 2006 entitled “Method and Apparatus for Digital Automatic Display of Pictures in a Picture Frame.”

### BACKGROUND

1. Field of the Invention

The present invention relates the use of digital picture frames to display image files stored on computer storage media.

2. Description of the Related Art

With the increasing popularity of digital cameras that store digital photos on computer flash memory cards, there has also been a corresponding increase in popularity of devices that can display digital photos directly from a variety of different non-volatile storage media.

Prior to the invention of digital picture frames, people only had two options to display digital photographs, on a computer or to print them. Displaying them on the computer does not offer much flexibility as to when and where the pictures can be displayed. While printing digital photos permits them to be displayed as traditional photographs, printing the photos can be time consuming and expensive. The use of a digital picture frame as a means to display digital photos directly from digital storage media is a means to overcome the disadvantages of the prior methods of displaying digital photographs.

The present invention improves on the use of digital picture frames as a means to display digital photos. One limitation of the prior art is that no method is presently known which facilitates the automatic display of pictures of different sizes and orientations. The present invention permits a picture frame to automatically detect the orientation of a picture, resize it and draw the photo in the appropriately shaped area of the picture frame creating a collage effect.

### SUMMARY OF THE INVENTION

According to the present invention, a method of determining a picture's orientation, and then its subsequent placement in a digital picture frame with multiple display areas of varying size based on its orientation is provided.

The preferred embodiment of this invention will have the ability to utilize any of the standard digital flash media format including, but not limited to: secure digital, XD, memory stick and compact flash. In the spirit of the invention, those skilled in the art will be able to adapt any future digital flash media formats to this invention.

When the control chip interfaces with the digital flash media, the control chip is able to read the digital image and multimedia files. In the preferred embodiment, the controller chip will be able to read all of the standard multimedia file formats including digital images and audio/visual files.

Another function of the controller chip is to determine the orientation of the files. In the preferred embodiment, the orientation is determined by measuring the edges of the image. If the vertical edge is longer the horizontal edge, the orientation is said to be portrait. If the horizontal edge is longer then the vertical edge, the orientation is said to be landscape. Those skilled in the art will be able to utilize other methods of determining the orientation.

The controller chip also has the ability to divide the display unit into a number of display areas of varying sizes and orientations so that multiple files can be displayed simultaneously. The controller chip will create the display areas based on the orientation of images that have been selected for display.

After determining what display areas to create based on the selected files, the controller chip will instruct the video decode to resize and draw the files into the appropriate display areas. The controller chip will know to replace older images with newer images.

Files that are tagged as a favorite are handled differently. Instead of being resized and drawn in a display area, they are resized and drawn to occupy the full size of the display unit.

Files are tagged as a favorite through the use of the onscreen display. The onscreen display is activated and manipulated by the use of the button controls. In addition to tagging images as favorites, the onscreen display can perform a number of functions. Typical functions that an onscreen display typically can perform is adjusting the contract, brightness, color, etc. . . .

The preferred embodiment will also have a slideshow function, to display a series of images. Files that are tagged as favorites will be displayed more often.

The novel features which are characteristic of the invention, both as to structure and method of the operation thereof, together with further objects and advantages thereof, will be understood from the following description, considered in connection with the accompanying drawings, in which the preferred embodiment of the invention is illustrated by way of example. It is to be expressly understood, however, that the drawing are for the purpose of illustration and description only, and they are not intended as a definition of the limits of the invention.

### BRIEF DESCRIPTION OF THE DRAWINGS

FIG. 1 is a block diagram of the present invention;

FIG. 2 is a front view of the exterior of the present invention;

FIG. 3 is a right side view of the exterior of the present invention;

FIG. 4 is an elevated, top view of the exteriors of the present invention;

FIG. 5 is a illustrates how the display is divided into different display areas;

FIG. 6 is a flowchart of the method of the present invention; and

FIG. 7 is a flowchart detailing the method of the present invention's slideshow function.

### DETAILED DESCRIPTION OF THE INVENTION

The present invention provides a method and apparatus for the automatic detection and display of images in a digital picture frame. In the following description, specific components and method steps are described in order to give a more thorough understanding of the present invention. In other instances, well-known elements such as the details of various construction materials are not described in detail so as not to obscure the present invention unnecessarily.

When a digital camera takes a photograph, the image is recorded in one of a number of different standardized image file formats. As a result, it is obvious to one skilled in the art that digital photo frames will have the ability to display any number of digital image files, and is not just limited to digital photographs.

In addition to making digital still photos, many digital cameras also have the ability to make audio/video recordings in any one of a number of different standardized digital audio/video file formats. As a result, it is obvious to one skilled in the art that digital photo frames will also have the ability to playback these digital audio/video files. For the purposes of this invention, digital audio/video files will be manipulated in the same manner as digital image files.

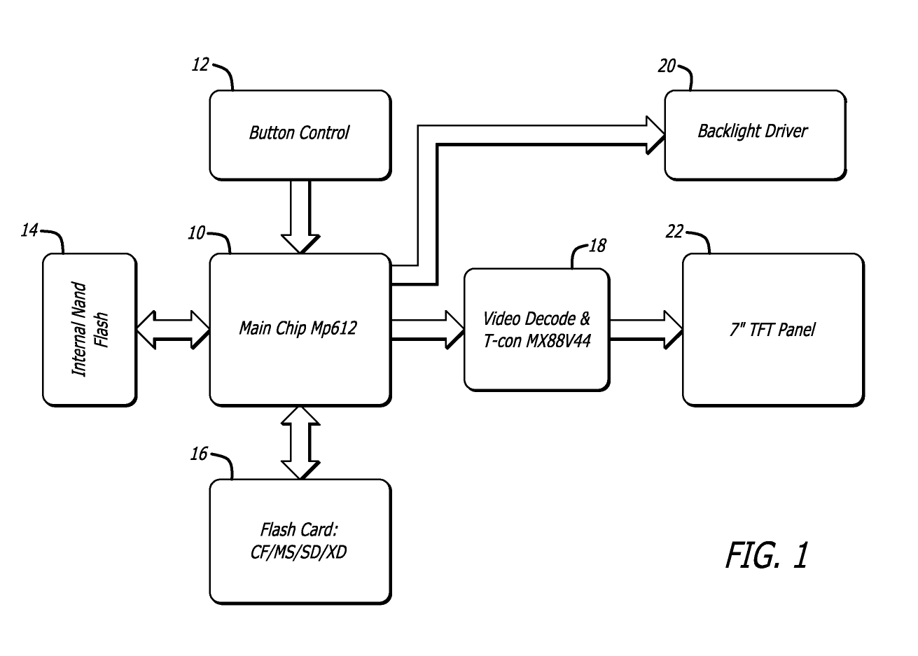

Referring first to FIG. 1, a block diagram showing the major electronic components of the preferred embodiment of the invention is shown. A controller chip 10 is connected to a button control 12, internal Nand flash 14, video decode chip 18 and backlight driver 20. Both the video decode chip 18 and backlight driver 20 are connected to a display unit 22. A storage media 16 interfaces with the control chip 10. The method of interface between the storage media 16 and control chip is well known to those of skill in the art.

In the present embodiment, storage media 16 can be any of a number of popular formats including, but not limited to, compact flash, memory stick, secure digital or XD. Those skilled in the art will be able to adapt the invention to work with any currently unknown and all future flash memory card formats.

The preferred embodiment of the present invention uses a 7″ TFT flat panel as the display unit 22. It has been found that 7″ TFT display results in a device that is similar to a traditional picture frame, and is pleasing to the eye. It will be apparent to those of skill in the art, however, that the display unit may be of a different size or type. For example, a larger TFT display can be used in the event that it is desired to display a larger size picture. Any size display can be used with equal effectiveness. Also, the TFT display can be replaced with a different type of display technology such as LCD, plasma, or a traditional CRT display. The present invention is not intended to be limited to a specific type or size of device for the display unit 22.

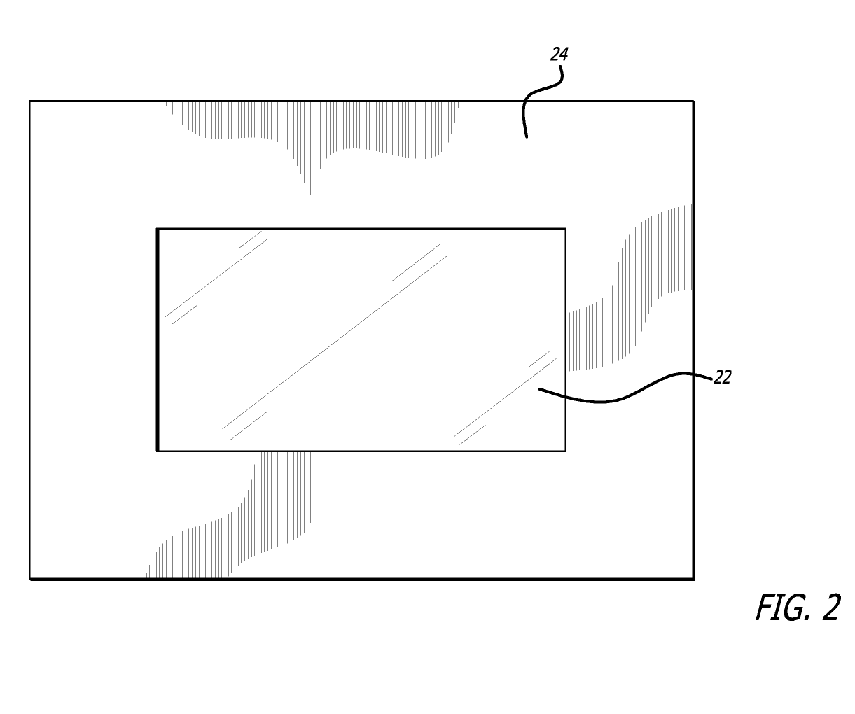

Referring next to FIG. 2, a front view of the exterior of the present invention is shown. In the preferred embodiment, the major components of the invention are housed within the external housing 24. Display unit 22 is viewable externally.

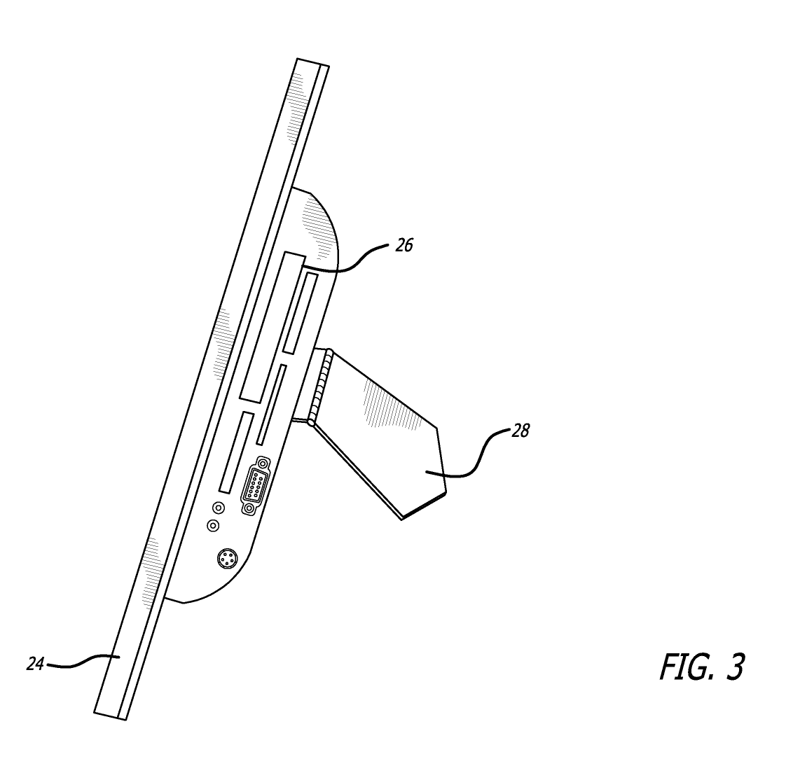

FIG. 3 is a right side view of the exterior of the picture frame. Visible along the right side of the external housing 24, are a series of slots 26. Slots 26 are adapted to accept the storage media 16. In the preferred embodiment, a plurality of slots 26 is present to accommodate the variety of sizes and shapes of the different types of storage media 16. The storage media 16 is inserted through the external housing 24 to interface with controller chip 10. It will be apparent to those skilled in the art that the slots 26 for inserting storage media 16 is not limited to the right side of the device, but they can also be located in any other suitable location, such as along the left side or on top.

Also visible in FIG. 3 is picture frame stand 28 attached to external housing 24. Picture frame stand 28 keeps the digital picture frame in an upright position when displayed on a horizontal surface. It will be apparent to those skilled in the art that the invention is not limited to display on a horizontal surface and mounting on a vertical surface is another way of displaying the invention.

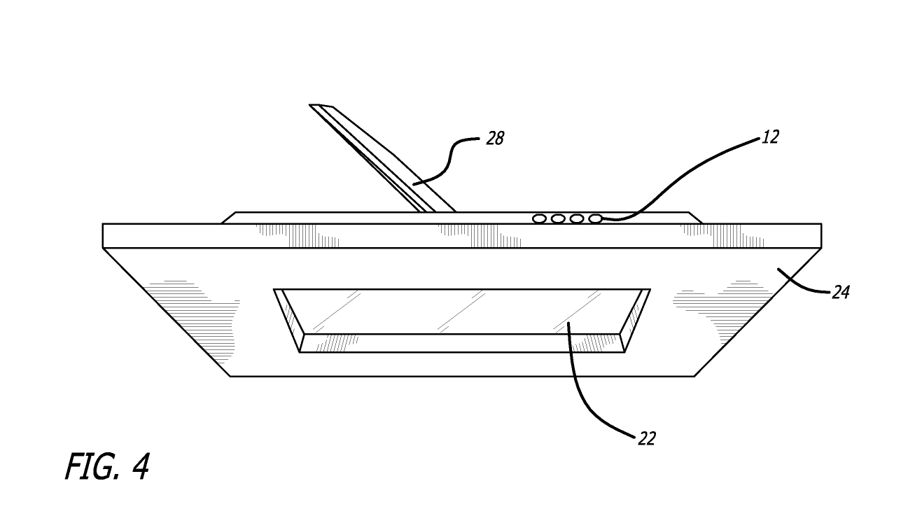

A top view of the external housing 24 is shown in FIG. 4. In the preferred embodiment of the invention, the button control 12 is mounted on the top of the external housing 24. However, those skilled in the art will know that the button control 12 can also be placed in other locations with equal effectiveness, such as on the left or right side of the picture frame. The picture frame stand 28 and 7″ TFT panel 22 are also visible in the top view.

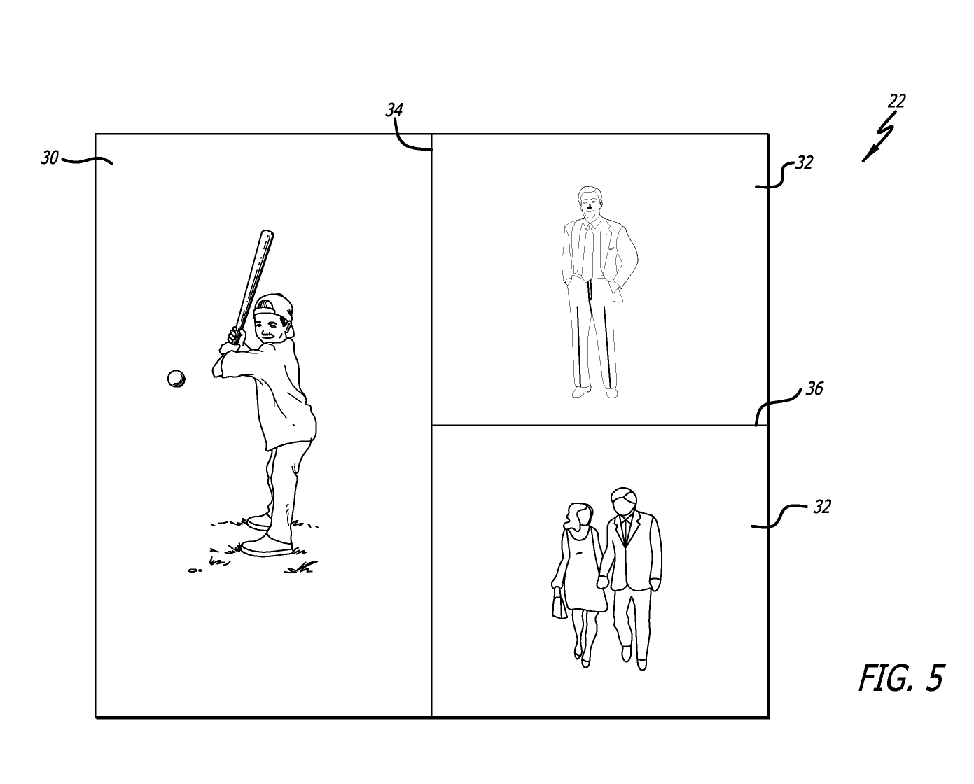

FIG. 5 illustrates how the display unit 22 is divided into different display areas. The preferred embodiment of the invention will have one half-display area 30 and two quarter-display areas 32. Vertical separator line 34 separates the half-display area 30 from the two quarter-display areas 32. A horizontal separator line 36 that extends from approximately the midpoint of the vertical separator line 34 to the side opposite of the first display area forms the next two display areas. These two display areas have similar dimensions and are used to display digital images that are in the horizontal orientation. These display areas are quarter-screen display areas 32.

It will be apparent to those of skill in the art that the display areas can be arranged in different manner or orientation from that shown in FIG. 5 without departing from the overall spirit and scope of the present invention. It is to be understood that the vertical separator line 34 and horizontal separator line 36 are not fixed within the display panel 22. Rather, the controller chip 10 draws the vertical separator line 34 and horizontal separator line 36 dynamically based on the number and orientation of the pictures to be drawn. For example, one alternative display area arrangement could be to have two half-screen display areas 30 separated only by a vertical separator line 34 located approximately at the midpoint on the horizontal axis. Such a display area configuration would display two portrait-oriented images. Yet another possible alternative display area arrangement could be four quarter-screen display areas 32 formed by the vertical separator line 34 and a horizontal separator line 36 that extends the full horizontal length of the display unit 22. Such an arrangement would result in four display areas to display four 32 landscape oriented digital images.

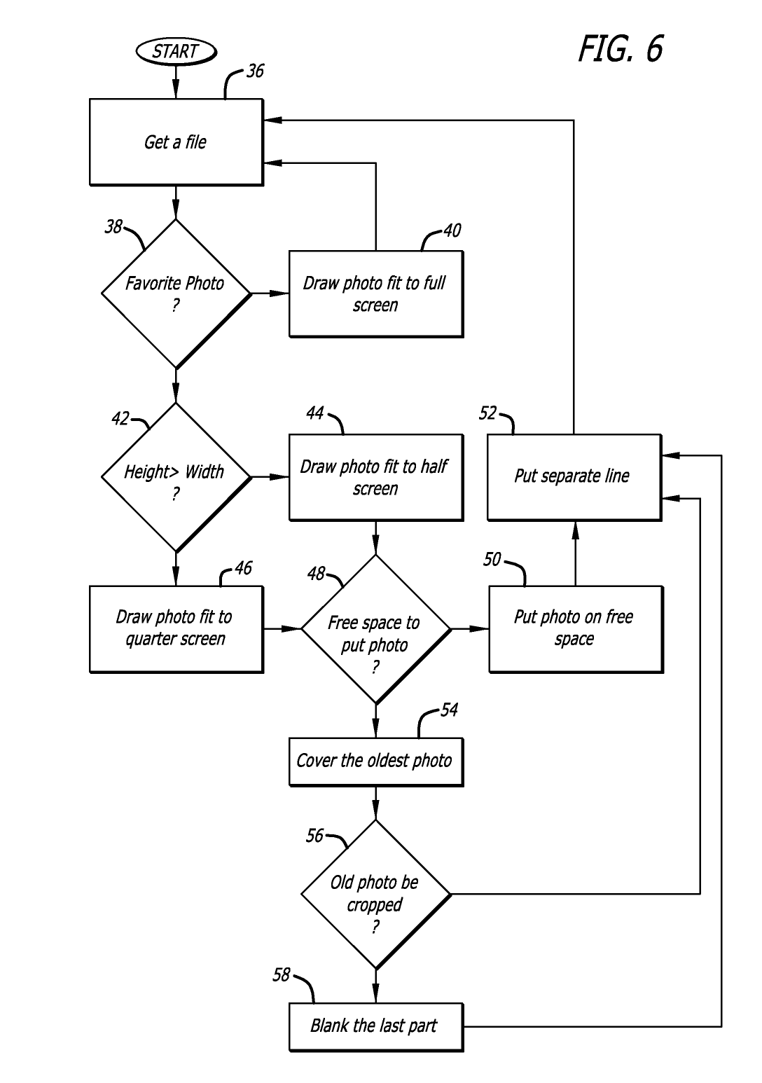

Referring next to FIG. 6, a flowchart is shown which illustrates the major steps that are employed in the method used in the present invention to display pictures on the display unit 22. The process begins at step 36 where a digital image file is retrieved from a storage media 16 interfacing with the controller chip 10. In step 38, controller chip 10 determines if the user has tagged the digital image as a favorite. If digital image file has been tagged as a favorite, then controller chip 10 will instruct the video decode chip 18 to draw the image file to fit the entire display unit 22 in step 40. Image files are tagged as favorites by utilizing the onscreen display. The onscreen display is activated and navigated through the manipulation of button control 12. Onscreen displays are well known in the art.

If the image file is not tagged as a favorite, then the controller chip 10 determines the orientation of the image file in step 42. In the preferred embodiment, the controller chip determines the orientation of the image file by counting the number of pixels along the horizontal and vertical edges of the digital image file. A digital image file with a vertical axis greater then its horizontal axis goes to step 44. On the other hand, a digital image file with a horizontal axis that is greater then its vertical axis goes onto step 46.

Other methods of determining the orientation of the image can also be employed with equal effectiveness. For example, the controller chip may use image recognition techniques to determine if a person's face is part of the photograph. The picture could then be displayed so that the head of the person is always oriented upward, regardless of the size or aspect ratio of the image file. Similarly, optical character recognition (“OCR”) techniques can be used to determine if the image includes alphanumeric text. In that event, the picture can be displayed in such a manner that the alphanumeric text will be properly displayed. It is to be understood that the method of determining the orientation of the picture in step 42 is not intended to be limited to the technique of counting pixels, which is used in the preferred embodiment.

Referring again to FIG. 6, in step 44 the controller chip 10 resizes the digital image file to fit into the display area for portrait-oriented photos 30. In step 46, the controller chip 10 resizes the digital image file to fit into the display area for landscape-oriented images 32. The landscape orientation is characterized by having a horizontal axis that is longer then the vertical axis. On the other hand, if the vertical axis is longer then the horizontal axis, that is referred to as the portrait orientation.

After the controller chip 10 determines the orientation of the digital image, it then decides where to draw the digital image within the display area. Digital images determined by the controller chip 10 to be in portrait orientation are placed in the half size area. Pictures determined by the controller chip 10 to be in landscape orientation are placed in the quarter size area.

The controller chip will draw a digital image into an empty display area if available. But, if the user wishes to display more then three pictures (in the preferred embodiment), the controller chip 10 will have to replace some pictures. The main chip will cover up older digital images first. The controller chip 10 accomplishes this by checking to see if the display area where the digital image file is to be displayed is free or not. If the appropriate display area 30 or 32 is free, then in step 50, the digital image is drawn into the appropriate display area, display area 30 for portrait oriented digital images or display area 32 for landscape oriented images. After the digital image is drawn in the appropriate display separator lines 34 and 36 are drawn in step 50.

If display area 30 or 32 is not free, then controller chip 10 will cover the oldest image file in step 54. If the old image file needs to be cropped, then controller chip 10 will do so in Step 56 and then draw in the vertical separator line 34 and vertical separator line 36 at step 52. If the old image file does not need to be cropped, then the controller chip 10 will blank the last part in step 58 and draw in the vertical separator line 34 and horizontal separator line 36 at step 52.

It will be apparent to those skilled in the art that the drawing of photos in the display area is not limited to covering up the oldest photo. Other methods of drawing the digital images files within the display areas are possible. For example, digital images can be overlapped.

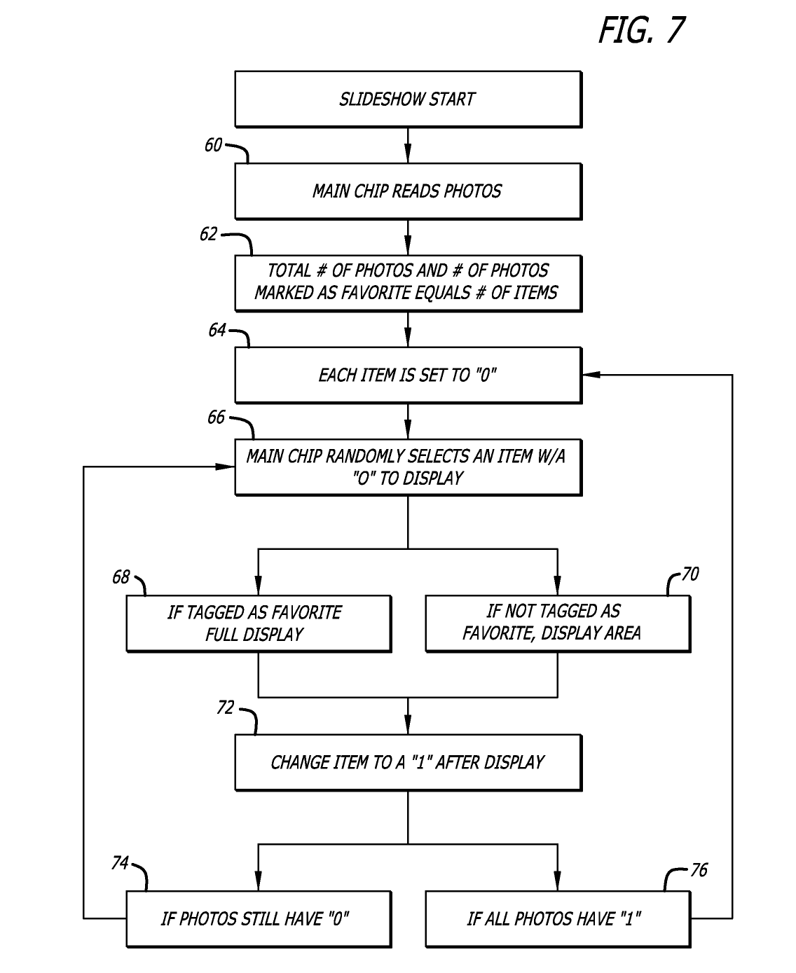

Finally, FIG. 7 is a flowchart of the method that the preferred embodiment employs to display a series of image files as a slideshow.

Beginning in step 60, controller chip 10 reads the image files on storage media 16. Proceeding to step 62, controller chip 10 calculates the total number of display items to display by adding the total number of image files on storage media 16 with the number of image files marked as favorites. In step 64, all of display the items are tagged with a “0.”

After all the display items are tagged with a “0,” controller chip 10 proceeds to randomly select a display item in step 66. If the digital item is additionally tagged as a favorite, the controller chip 10 will display the display item in the full display at step 68. If the selected display item is not additionally tagged as a favorite, the controller chip 10 will select an appropriate display area to display the display item at step 70.

After a display item is displayed in step 68 or 70, the controller chip 10 will replace the “0” tag with a “1” tag in step 72. If there are still remaining display items marked as “0”, controller chip 10 will proceed to step 74. In step 74, the selection and display process will repeat starting at step 66. If all the digital items are tagged with a “1”, the controller chip 10 will proceed to step 76. In step 76, the process will repeat starting step 64 and all the display items will be tagged with a “0.”

Accordingly, a method for displaying images in a digital picture frame has been described. It is to be understood that the foregoing description has been made with respect to specific embodiments thereof for illustrative purposes only. The overall spirit and scope of the present invention is limited only by the following claims, as defined in the foregoing description.

1. (canceled)

2. (canceled)

3. (canceled)

4. (canceled)

5. (canceled)

6. (canceled)

7. (canceled)

8. A method for displaying a series of photographs or digital image files on a digital picture frame comprising the steps of:
(a) retrieving a plurality of digital image files from a digital storage media device;
(b) calculating the number of display items by adding the total number of image files to display on said digital storage media device with the number of images files to display that are tagged as favorites;
(c) tagging each of said display items with a “0”;
(d) one of said display items that are tagged with a “0” is selected randomly;
(e) if said display item is tagged as a favorite, said item is displayed full screen, if said item is not tagged as a favorite, said item is displayed in an appropriate display area; and
(f) after said item is displayed, said item's tag is replaced.

9. The method of claim 8, further comprising repeating steps (d) through (f) for every digital image tagged with a “0”.

10. The method of claim 8, further comprising returning to step (c) when every digital image has been tagged with a “1”.
